(19) United States
(12) Patent Application Publication
(10) Pub. No.: US 2008/0016997 A1
(43) Pub. Date: Jan. 24, 2008

(54) Method of cutting cellular shade and cutting machine thereof

(75) Inventors: Ming Nien, Lugang Township (TW); Wen-Yeu Lee, Tainan City (TW)

Correspondence Address: RABIN & Berdo, PC, 1101 14TH STREET, NW, SUITE 500, WASHINGTON, DC, 20005, US

(73) Assignee: Nien Made Enterprise Co., Ltd., Taichung City (TW)

(21) Appl. No.: 11/517,373

(22) Filed: Sep. 8, 2006

(30) Foreign Application Priority Data
Jul. 4, 2006 (CN) 200610090937.8

(51) Int. Cl. B26D 1/00

(52) U.S. Cl. 83/13

(57) ABSTRACT

A method of cutting a cellular shade and a cutting machine thereof mainly applicable for cutting an assembled cellular shade to a certain size is provided. The cutting method includes providing an assembled cellular shade; providing a cutting machine having a sawing mechanism and a chopping mechanism; pulling out beams of the cellular shade, such that the beams and a cellular piece are staggered, and performing a beam cutting operation; and pulling out the cellular piece, such that the cellular piece and the beams are staggered, and performing a cellular piece chopping operation. The cutting machine mainly includes a table with at least one cutting work area disposed thereon. Using the assembly feature of the cellular shade, the beams and the cellular piece are staggered for a small distance temporarily. The beams are sawed with the sawing mechanism on the table, and the cellular piece is chopped with the chopping mechanism sequentially, such that the measuring and cutting operations of the cellular shade are performed quickly on a single table.

### CROSS-REFERENCE TO RELATED APPLICATIONS

This non-provisional application claims priority under 35 U.S.C. § 119(a) on Patent Application No(s). 200610090937.8 filed in China, P.R.C. on Jul. 4, 2006, the entire contents of which are hereby incorporated by reference.

### BACKGROUND OF THE INVENTION

1. Field of Invention

The present invention relates to a method of cutting a cellular shade and a cutting machine thereof. More particularly, the present invention relates to a method of cutting the metal beams and cloth cellular piece of an assembled cellular shade to a certain size on a single table and a cutting machine thereof.

2. Related Art

Presently, cellular shades are quite popular because of their simple style and unique cell design. The cellular shades store air in the hollow layer of the cellular piece to maintain the constant indoor temperature, and their functions of insulating ultraviolet light and heat can effectively protect the furniture and carpet. Moreover, the cellular shades can absorb 30% of the noise. Normal window shade manufacturers have to preset the shades to different lengths and widths when the shades are produced for the retail in market, and consumers have to buy these specs of shades available on market, or have to customize shades with required size.

The structure of a common cellular shade comprises an upper beam, a lower beam, and a cellular piece inbetween (another structure comprising an upper beam, one or two middle beams, a lower beam, and cellular pieces with each of the pieces between two neighboring beams is also available), and the cell piece inbetween is connected with support lines between the beams. The beams described above are mainly made of a metal material such as aluminum or iron, and the cellular pieces are made of paper, cloth, or non-woven cloth. If the two kinds of components of different materials are cut with a single cutter at the same time, the cut sections will often have burrs and raw edges. As the cellular pieces are strictly required to be clean, and the non-woven cloth material is very easy to get contaminated during the mixed cutting, presently to cut the cellular shades purchased by the consumers, the beams and cellular pieces are cut by the manufacturers according to the required size using cutting machines with different cutters, and then are assembled.

Though the method of cutting a cellular shade will not cause burrs, raw edges or contamination of the metal beams and cellular pieces, as the cutting has to be performed before the products are assembled, the consumers' demand cannot be met on time. Further, as the specs are ordered uniquely or in a small batch, the cost is very high, and the competitiveness is low.

### SUMMARY OF THE INVENTION

Accordingly, the technical problem to be solved by the present invention is to provide a cutting method that may cut beams and cellular pieces respectively on a single table without disassembling assembled cellular shade products.

Another technical problem to be solved by the present invention is to provide a cutting machine of a cellular shade that may perform measuring and cutting on a single table without disassembling the structure of beams and cellular pieces of the cellular shade.

To achieve the aforementioned objects, the technical scheme given in the present invention is to provide a method of cutting a cellular shade comprising at least two beams and a cellular piece. The method comprises providing a cutting machine having a table, a sawing mechanism, and a chopping mechanism; performing the beam cutting, including keeping the cellular shade in the assembled state, pulling out the beams for a small length, such that the beams and the cellular piece are staggered, and placing the beams into the sawing mechanism to perform the measuring, holding and cutting operations; and performing the cellular piece cutting, including keeping the cellular shade in the assembled state, pulling out the cellular piece for a small length, such that the cellular piece protrudes, and the cellular piece and the beams are staggered, and placing the cellular piece into the chopping mechanism to perform the measuring, holding and cutting operations.

To realize the aforementioned cutting method, the present invention makes full use of the structural features of the assembly of the beams and the cellular piece of the cellular shade, and designs a cutting method that forms the cutting space by moving the beams or cellular piece for a small length. The technical scheme provided by the present invention provides a cutting machine of a cellular shade, which comprises a table; a sawing mechanism disposed on the table and having a first measuring device, a first pressing device, and a sawing device, for measuring the cutting size of the beams, pressing the beams and sawing the beams; and a chopping mechanism disposed on the table and having a second measuring device, a second pressing devices, and a chopping device, for measuring the cutting size of the cellular piece, pressing the cellular piece and chopping the cellular piece.

The advantages of the present invention lie in that the overall efficiency of cutting the cellular shade is improved significantly. The steps of “disassembling the beams and the cellular piece, cutting the beams and the cellular piece on different tables respectively, and assembling the beams and the cellular piece” are simplified to direct measuring and cutting in the assembled state in the present invention, which meets the consumers' requirements on instant cutting and variable sizes.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below for illustration only, and which thus is not limitative of the present invention, and wherein:

FIG. 1 is a flow chart of the steps of the cutting method according to a preferred embodiment of the present invention.

FIG. 2 is a flow chart of the steps of the beam cutting operation according to a preferred embodiment of the present invention.

FIG. 3 is a flow chart of the steps of the cellular piece cutting operation according to a preferred embodiment of the present invention.

FIG. 4 is a schematic view of an assembled cellular shade in the closed state according to a preferred embodiment of the present invention.

FIG. 5 is a combined stereogram of a cutting machine according to a preferred embodiment of the present invention.

FIG. 6 is a schematic stereogram of the sawing mechanism according to a preferred embodiment of the present invention.

FIG. 7 is a schematic stereogram of the chopping mechanism according to a preferred embodiment of the present invention.

FIG. 8 is a top view of the sawing mechanism according to a preferred embodiment of the present invention.

FIG. 9 is a top view of the chopping mechanism according to a preferred embodiment of the present invention.

FIGS. 10A and 10B are schematic views of the actions of the first measuring device according to a preferred embodiment of the present invention.

FIGS. 11A and 11B are schematic views of the actions of the second measuring device according to a preferred embodiment of the present invention.

FIG. 12 is a top sectional view of the guiding portion and the flange potion of the guiding and positioning cover according to a preferred embodiment of the present invention.

FIG. 13 is a schematic stereogram from another angle of the sawing mechanism of according to preferred embodiment of the present invention.

FIG. 14 is a schematic stereogram from another angle of the chopping mechanism according to a preferred embodiment of the present invention.

### DETAILED DESCRIPTION OF THE INVENTION

A preferred embodiment is illustrated in detail with reference to the drawings.

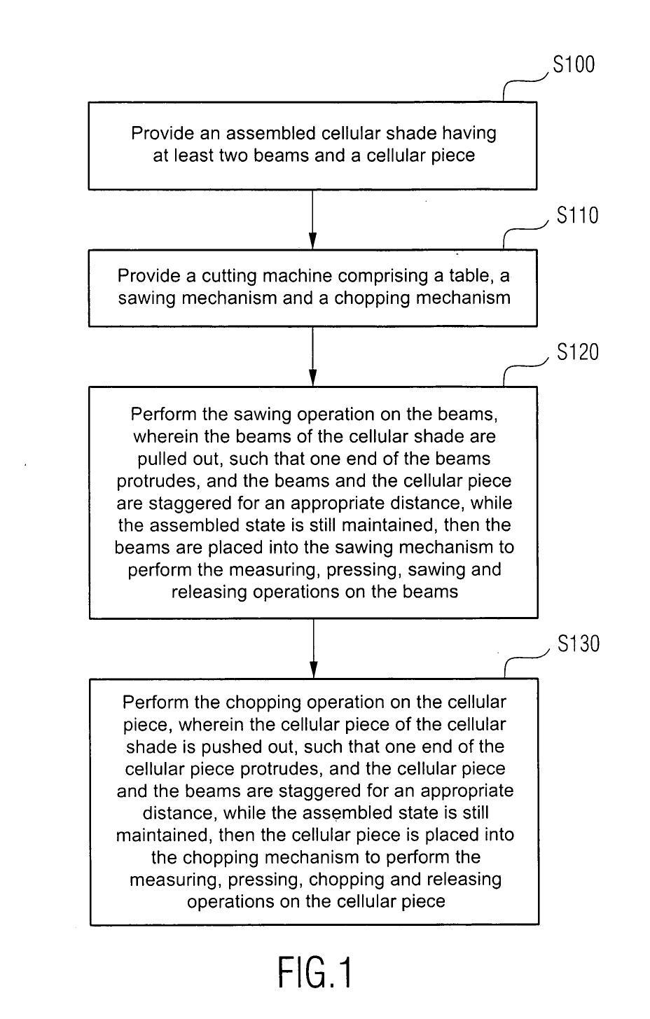

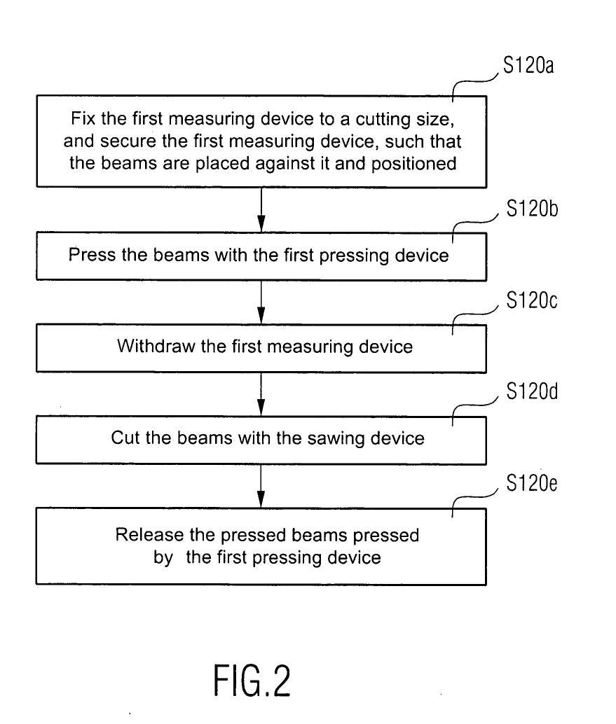

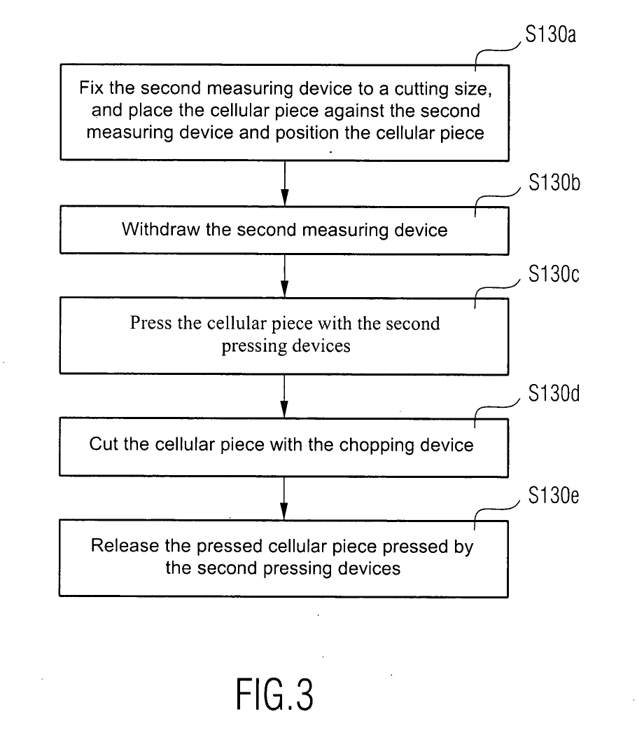

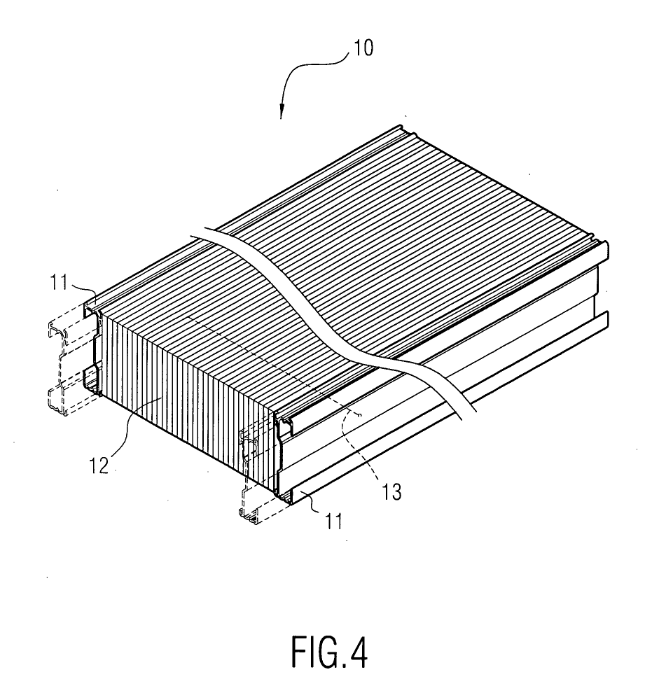

Referring to the flow charts of FIGS. 1, 2, and 3, and the structural views of FIGS. 4, 5, 6, and 7, the cutting method of the present invention comprises the following steps.

An assembled cellular shade 10 having two beams 11, a cellular piece 12, and a support line 13 connected inbetween is provided first (Step S100), and then a cutting machine 20 (Step S110) comprising a table 30, a sawing mechanism 40 and a chopping mechanism 50 is provided.

Then the sawing operation on the beams 11 is performed (Step S120), wherein the two beams 11 of the cellular shade 10 are pulled out, such that the beams 11 protrudes from the end of the side edge of the cellular shade 10, such that the beams 11 and the cellular piece 12 are staggered, as the dashed lines in FIG. 4 show. And instead of being disassembled, the assembled state that the support line 13 is threaded between the beams 11 and the cellular piece 12 is still maintained. After that, the cellular shade 10 is placed into the sawing mechanism 40 to perform the measuring, pressing, cutting and releasing operations on the beams 11. The sawing mechanism 40 described in the operation (Step 120) further comprises a first measuring device 41, a first pressing device 42, and a sawing device 43. The operation includes measuring, pressing, cutting, and releasing, which represent the following four steps respectively: marking the size to cut with the first measuring device 41 and fixing so as to position the placed beams 11 (Step S120a), pressing the beams 11 with the first pressing device 42 (Step S120b), then withdrawing the first measuring device 41 from the beams 11 (Step S120c) to prevent collision with the sawing device 43 in the subsequent cutting stroke, and cutting the beams 11 with the sawing device 43 (Step S120d). When the sawing device 43 is started, the first measuring device 41 has been withdrawn from the beams 11 earlier, so as to prevent the damage caused by the collision with the first measuring device 41 when the sawing device 43 moves downwardly. After the sawing device 43 is reset, the pressing state of the first pressing device 42 can be released to release the cellular shade 10 (Step S120e).

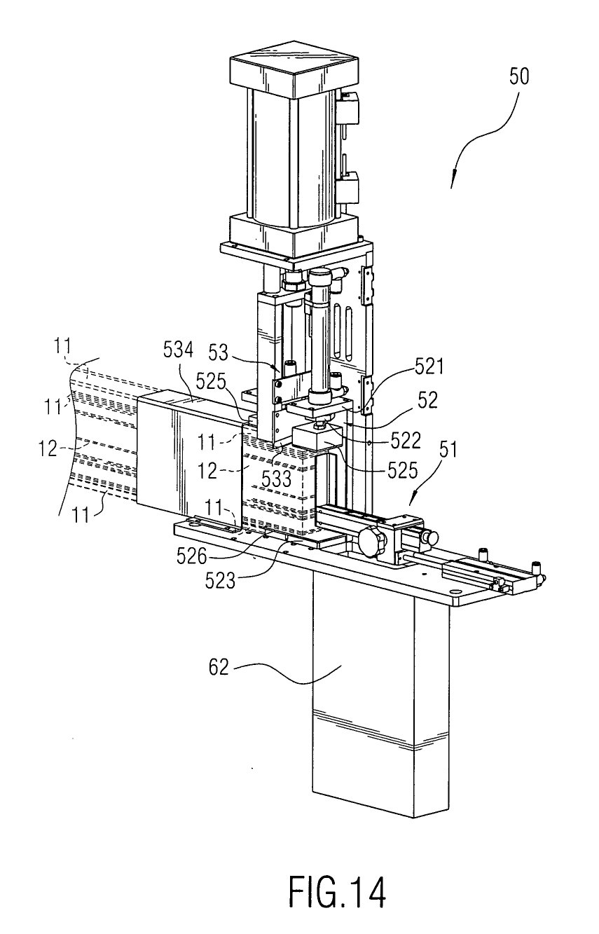

Then, the chopping of the cellular shade 120 is performed (Step S130). Firstly, the cellular shade is turned by 90 degrees, such that the beams are in vertical positions in a Z direction (as the directions of the beams 11 and the cellular piece 12 of FIG. 14 show). The cellular piece 12 of the cellular shade 10 is pushed out, such that the cellular piece 12 and the beams 11 are staggered, while the assembled state in which the supported line 13 is threaded is still maintained. The cellular shade 10 is placed into, the chopping mechanism 50 to perform measuring, pressing, cutting and releasing operations on the cellular piece 12. The chopping mechanism 50 described in the operation (Step 130) further comprises a second measuring device 51, second pressing devices 52, and a chopping device 53. The operation includes measuring, pressing, cutting, and releasing, which represent the following four steps respectively: marking the size to cut with the second measuring device 51 and fixing so as to position the placed cellular piece 12 (Step S130a), withdrawing the second measuring device 51 from the cellular piece 12 after the cellular piece 12 is positioned, such that it is not in contact with the cellular piece 12 (Step S130b), pressing the cellular piece 12 with the second pressing devices 52 (Step S130c), and cutting the cellular piece 12 with the chopping device 53 (Step S130d). Before the chopping device 53 is started and contacts the cellular piece 12, the second measuring device 51 has been withdrawn from the cellular piece 12 earlier, so as to prevent the damage caused by the collision with the second measuring device 51 when the chopping device 53 or the second pressing devices 52 move downwardly. After the chopping device 50 is reset, the pressing state of the second pressing devices 52 can be released to release the cellular shade 10 (Step S130e).

Certainly, in the method described above, whether the beams 11 or the cellular piece 12 of the cell 10 are cut causes no difference, i.e., Step S100 and Step S110 can be performed in a reversed order, and S120 and S130 can also be performed in a reversed order, and the implementation of the present invention is not influenced.

Moreover, in Step S100 of the aforementioned cutting method of the present invention, the beams 11 and the cellular piece 12 of the cellular shade 10 are not limited to have the structure of two beams 11 and a cellular piece 12 inbetween as described above, and can have a structure of over two beams 11 (e.g., three beams or even four beams) having a cellular piece 12 disposed between two neighboring beams 11.

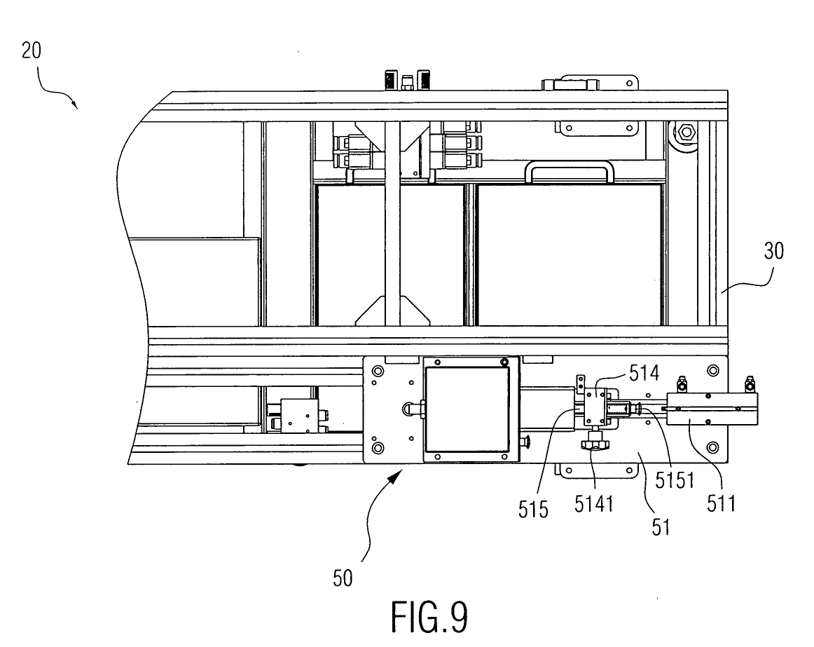

Referring to FIGS. 4, 5, 6, 7, 8, and 9, the cutting machine 20 used to realize the above steps in the present invention comprise the following components.

A table 30, which has a first work area 31 and a second work area 32 respectively for disposing the length directions of the beams 11 of the cellular shade 10 to cut along the direction of the X coordinate axis. Certainly, the aforementioned first work area 31 and second work area 32 can be arranged in a same plane, or be arranged in different planes.

A sawing mechanism 40 is disposed at one end of the first work area 31, and has a first measuring device 41, a first pressing device 42, and a sawing device 43. The first measuring device 41 is disposed on the table 30, and can move along the direction of the X coordinate axis, so as to adjust the distance to a saw blade 434 on the sawing device 43, and the distance is the length to be cut from the beams 11. The first pressing device 42 is disposed at another position on the table 30 on the plane of the first work area, and presses the beams 11 along the direction of the Y coordinate axis. The first measuring device 41 is withdrawn from the beams 11 (e.g., by means of sliding driven by pneumatic cylinders) after the beams are pressed, so as to prevent the collision with the sawing device 43. The sawing mechanism 43 is disposed between the first measuring device 41 and the first pressing device 42, and can move along the direction of the Z coordinate axis to cut the beams 11.

A chopping mechanism 50 is disposed on the second work area 32, and has a second measuring device 51, a pair of second pressing devices 52 disposed separately, and a chopping device 53 disposed between the two second pressing devices. The second measuring device 51 is disposed on the table 30, and can move along the direction of the X coordinate axis to adjust the distance from the chopping device 53, and the distance is the size of the cellular piece 12 to cut. The second pressing devices 52 are disposed at another position on the same X coordinate axis of the table 30, and press the cellular piece 12 along the direction of the Z coordinate axis. Before the chopping device 53 is started and contacts the cellular piece 12, the second measuring device 51 has been withdrawn from the cellular piece 12 earlier (e.g., by means of sliding driven by pneumatic cylinders) so as not to obstruct the chopping stroke of the chopping device 53. The chopping device 53 is disposed between the two second pressing devices 52, and has a chopping cutter 533 moving along the direction of the Z coordinate axis to cut the cellular piece 12.

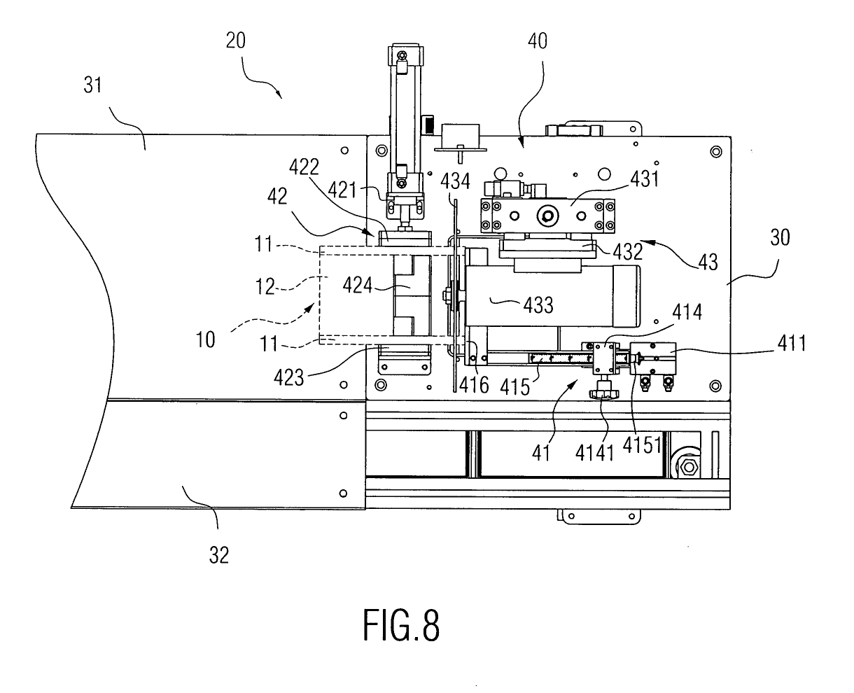

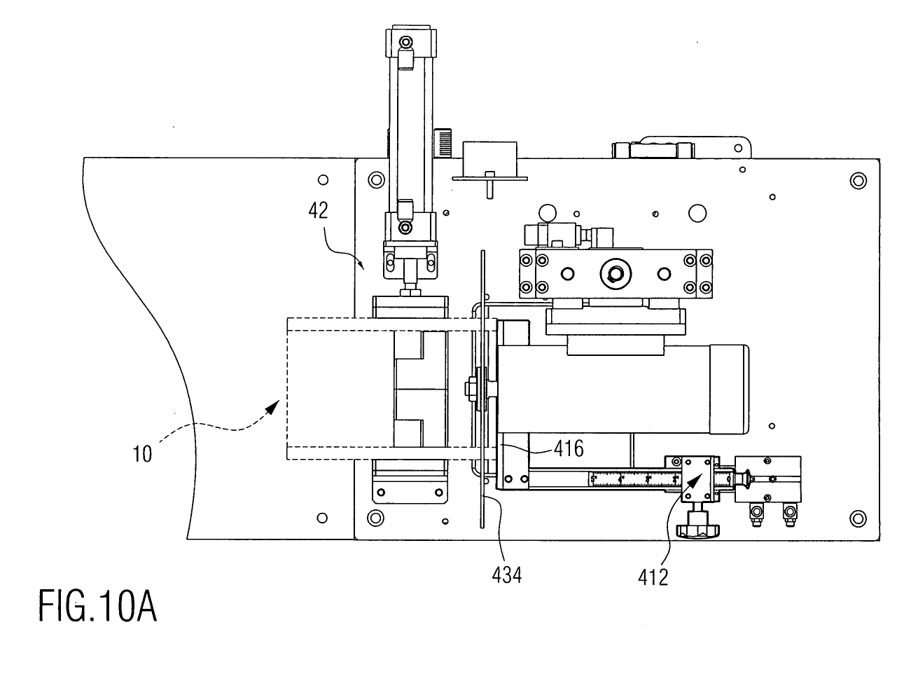

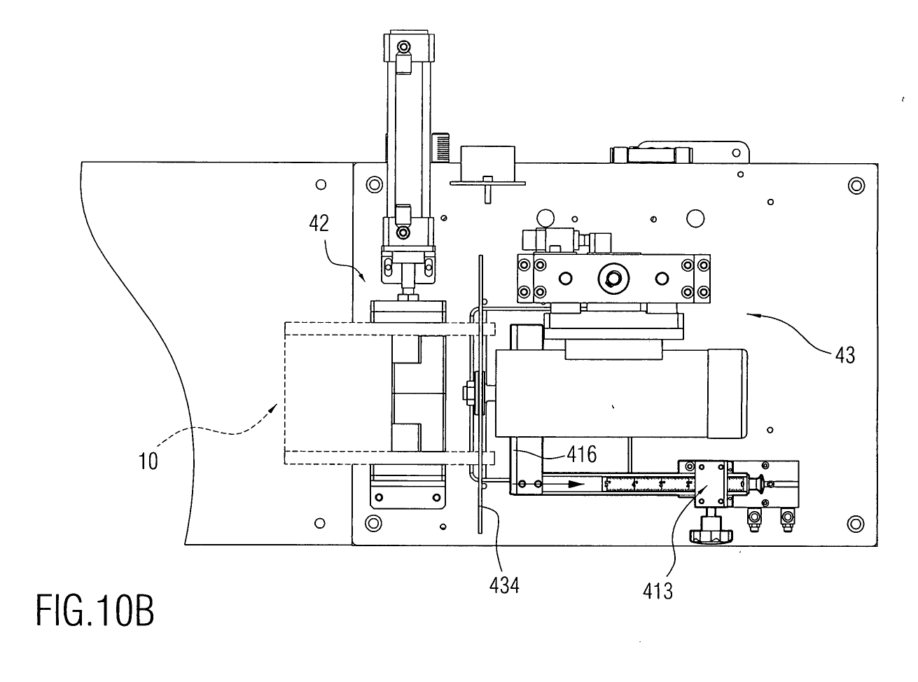

Referring to further descriptions on FIGS. 8, 10A, and 10B, the first measuring device 41 of the embodiment of the present invention comprises: a slide base component 411 fixed on the table 30, wherein the slide base component 411 includes a brake sliding block 414 movable between a first position 412 and a second position 413, and the brake sliding block 414 has a screw fixing member 4141; a freely movable vernier 415 disposed on the brake sliding block 414; and a positioning block 416 disposed at the end of the vernier 415.

When the first measuring device 41 operates, the brake sliding block 414 is at the first position 412, the position of the vernier 415 is adjusted to the length to cut by holding the handle of the vernier 415 manually, the vernier 415 is fixed with the screw fixing member 4141, such that the positioning block 416 precisely position the place where the beams 11 will be cut, and after the first pressing device 42 presses, the brake sliding block 414 is drawn back to the second position 413, such that the positioning block 416 leaves the cutting area where the beams 11 are.

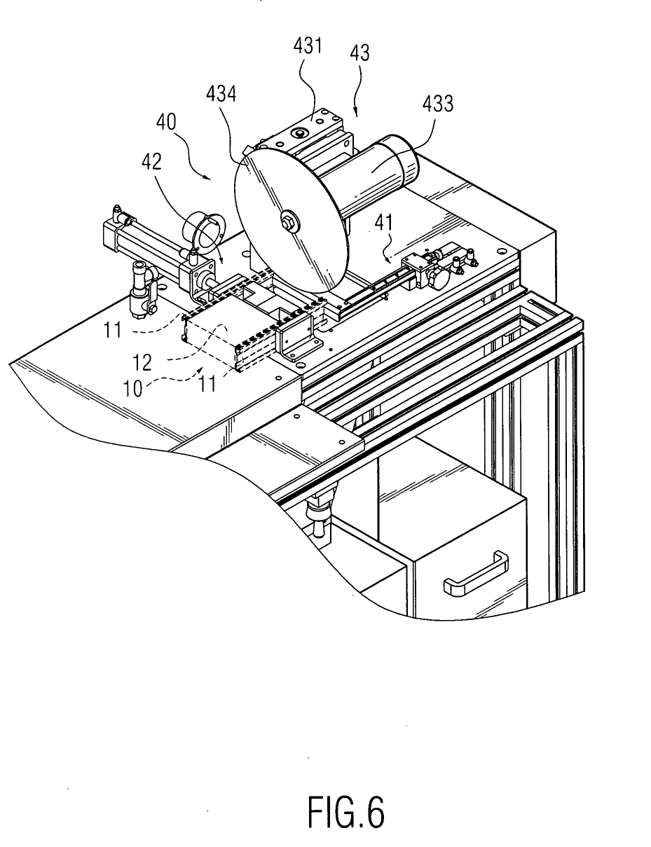

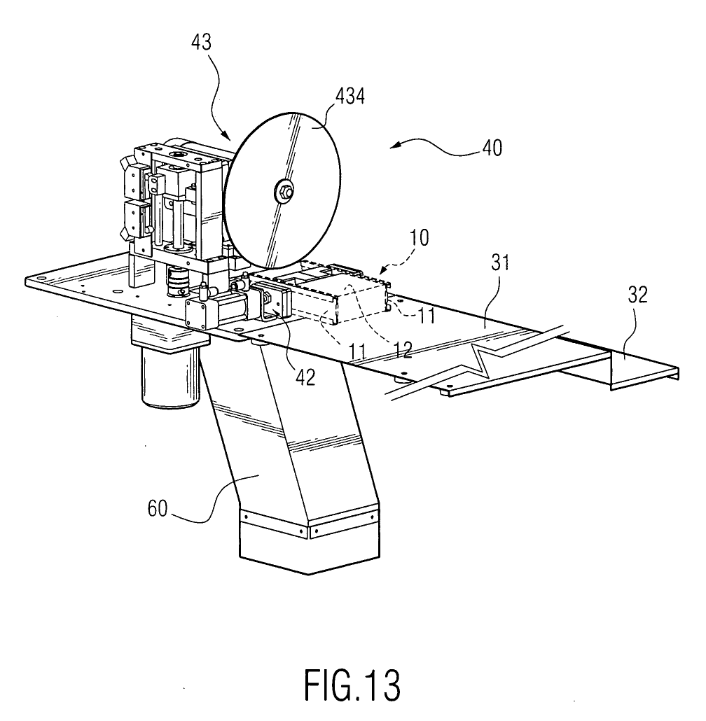

As shown in FIGS. 6, 8, and 13, the first pressing device 42 of the embodiment of the present invention comprises: a slide base component 421 fixed on the table 30, which has a pressure sliding block 422 that can actively move along the direction of the Y coordinate axis; a baffle 423 fixed on the table 30; and a cushion block 424 that can move linearly, individually, and freely between the pressure sliding block 422 and the baffle 423.

The sawing device 43 of the embodiment of the present invention comprises: a slide base component 431 fixed on the table 30, which has a sliding mechanism 432 movable along the direction of the Z coordinate axis; a cutter rotating mechanism 433 disposed in the sliding mechanism 432; and a saw cutter 434 assembled in the cutter rotating mechanism 433. Certainly, the saw cutter 434 is replaceable, and can be replaced after the cutter reaches its life span or when other specs of cutters are required.

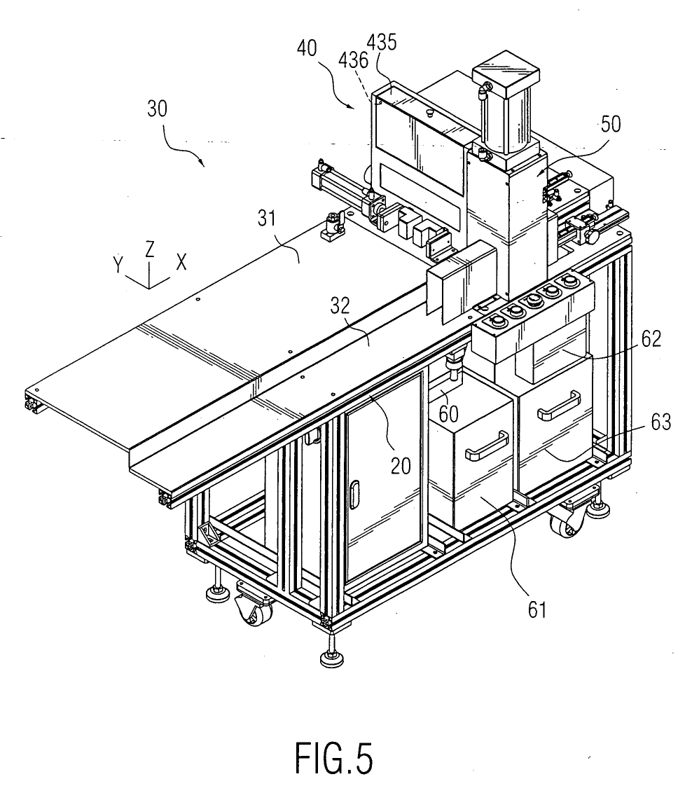

Furthermore, as shown in FIGS. 5, 6, and 13, the sawing device 43 further comprises an outer cover 435 to cover the saw cutter 434, and a microswitch 436 disposed at the opening position of the outer cover and connected to the power source of the rotating mechanism 433. When the outer cover 435 is opened, the power source of the rotating mechanism 433 is shut down to guarantee the safety of the operator.

The cutting of the cellular piece 20 with the chopping mechanism 50 of the present invention is implemented in a manner that the beams 11 are at upper and lower positions, and the cellular piece 12 is in the middle (as the beams 11 and the cellular piece 12 in FIG. 14 show), and detailed description on this is given below.

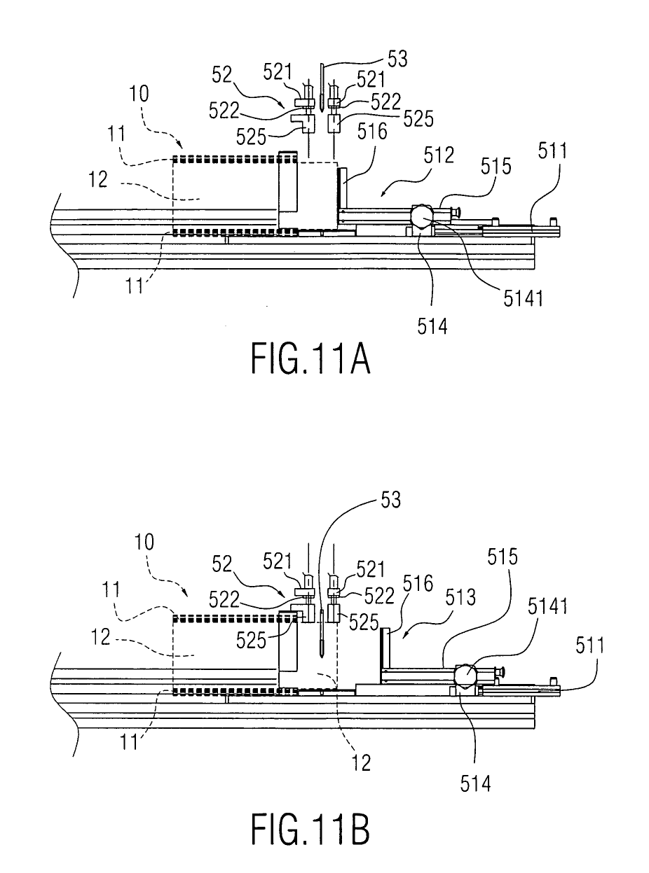

Referring to FIGS. 11A and 11B, and the stereogram of the embodiment of the cellular shade 10 of FIG. 14, the second measuring device 51 of the embodiment of the present invention comprises a slide base component 511 fixed on the table, which has a brake sliding block 514 movable between a first position 512 and a second position 513, and has a screw fixing member 5141; a freely movable vernier 515 disposed on the brake sliding block 514; and a positioning block 516 disposed at the end of the vernier 515.

Before the second measuring device 51 is actuated, the brake sliding block 514 is at the first position 512. The operator can adjust the positions of the vernier 515 and the positioning block 516 so as to obtain a correct cutting distance between the positioning 516 and the chopping device 53, and can use the screw fixing member 5141 to secure the relative position of the vernier 515 and the brake sliding block 514. Before the second pressing devices 52 presses, the brake sliding block 514 is drawn back to the second position 513, such that the positioning block 514 leaves the cellular shade 10 to prevent the collision with the second pressing devices 52.

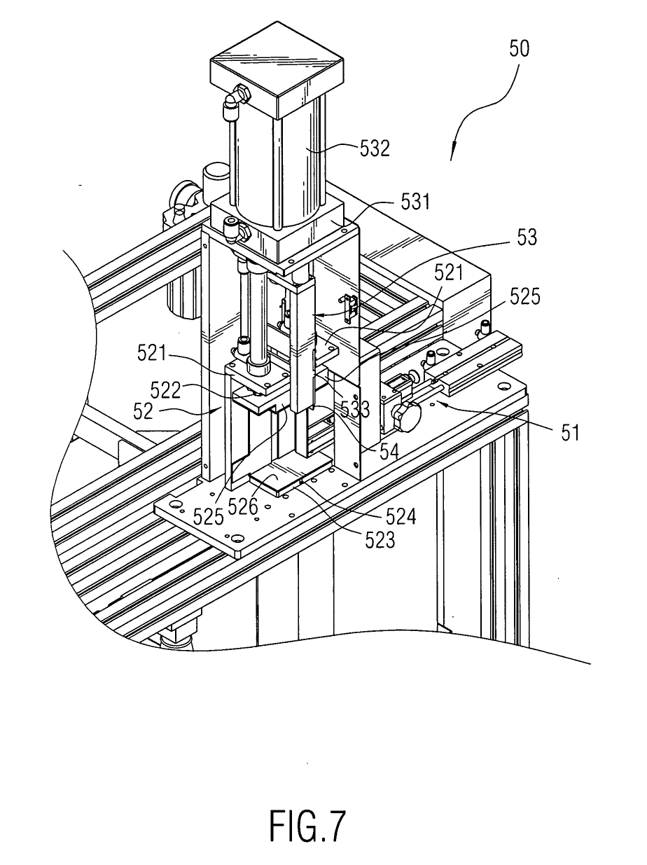

Referring to FIGS. 7 and 14, the second pressing devices 52 of the embodiment of the present invention comprise: a pair of slide base components 521 fixed on the table, each having a pressure sliding block 522 that can actively move along the direction of the Z coordinate axis respectively; a base plate 523 fixed on the table 30 with a groove 524 disposed thereon; and a pair of cushion blocks 525 that can move linearly, individually, and passively between the pressure sliding blocks 522 and the base plate 523. Thus, before the pair of the pressure sliding blocks 522 are pushed and actuated, the cellular piece 12 of the cellular shade 10 can be placed on the base plate 523, and after the pressure sliding blocks 522 are pushed and actuated, the cushion blocks 525 and the cellular piece 12 are pushed to the base plate 523 to press the cellular piece 12. Moreover, each of the surfaces in contact with the cellular piece 12 of the pressure sliding blocks 522, the base plate 523, and the cushion blocks 525 can have an additional contamination-proof pad 526, which can be made of acrylics or plastic.

As shown in FIGS. 7 and 14, the chopping device 53 of the embodiment of the present invention comprises: a slide base component 531 fixed on the table, which has a sliding mechanism 532 movable along the direction of the Z coordinate direction; and a chopping cutter 533 assembled in the sliding mechanism. Certainly, the chopping cutter 533 is installed replaceably to facilitate the replacement thereof.

Referring to FIGS. 5 and 14, the chopping device 53 further comprises a guiding and positioning cover 534 to guide the positioning of the cellular shade 10. The guiding and positioning cover 534 can be of a transparent material to facilitate the observation of the positioning of the beams 11 and the chopping device 53.

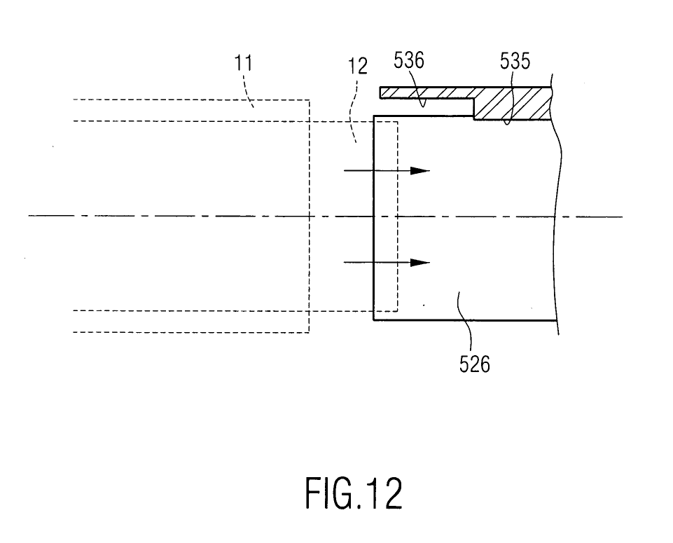

Referring to FIGS. 7, 12, and 14, the chopping device 53 further has a flange portion 535, which is disposed above the base plate 523 and the contamination-proof pads 526 of the table and is in front of the chopping cutter 533 relatively, and extends its thickness along the direction of the Z coordinate axis. The flange portion 535 is used to stop the beams 11 to enable the cellular piece to protrude, so as to facilitate the cutting. Furthermore, the chopping device 53 can further comprise a guiding portion 536, which is disposed on the table 30 and abuts on the flange portion 535, and extends in a direction parallel to the X coordinate axis. In addition to guiding and positioning, the guiding and positioning cover 536 can prevent direct contacts with the chopping cutter.

Referring to FIGS. 5, 13, and 14, a first waste channel 60 can be added at a position below the sawing device 43 corresponding to the sawing mechanism 40 on the table 30 of the present invention to guide the waste of the cut beams, and a first waste barrel 61 can be added at the end of the channel to collect the waste. Similarly, a second waste channel 62 can be added at a position below the chopping device 53 corresponding to the chopping mechanism 50 to guide the chopped waste, and a second waste barrel 63 can be added at the end of the channel to collect the waste.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A method of cutting a cellular shade, comprising:
providing an assembled cellular shade, wherein the cellular shade has at least two beams and at least one cellular piece;
providing a cutting machine, wherein the cutting machine includes a table, a sawing mechanism, and a chopping mechanism;
performing the sawing operation on the beams, wherein the beams of the cellular shade are pulled out, such that one end of the beams protrudes, and the beams and the cellular piece are staggered, while the assembled state is still maintained, then the beams are placed into the sawing mechanism to perform measuring, pressing, sawing, and releasing operations on the beams; and
performing the chopping operation on the cellular pieces, wherein the cellular pieces of the cellular shade are pushed out, such that one end of the cellular pieces protrudes out, and the cellular pieces and the beams are staggered, while the assembled state is still maintained, then the cellular pieces are placed into the chopping mechanism to perform measuring, pressing, chopping, and releasing operations on the cellular pieces.

2. The method of cutting as claimed in claim 1, wherein the sawing mechanism has a first measuring device, a first pressing device, and a sawing device inbetween; and the operations of the cutting mechanism in the step of performing the beam cutting operation further comprise:
fixing the first measuring device to a cutting size and locking the first measuring device, such that the beams are placed in and are positioned against the first measuring device;
using the first pressing device to press the beams;
withdrawing the first measuring device;
using the sawing device to cut the beams; and
releasing the beams pressed by the first pressing device.

3. The method of cutting as claimed in claim 1, wherein the chopping mechanism has a second measuring device, a pair of second pressing devices, and a chopping device disposed between the pair of the second pressing devices; and the operations of the chopping mechanism in the step of performing the cellular piece cutting operation comprise:
fixing the second measuring device to a cutting size, and placing the cellular pieces in to position the cellular pieces against the second measuring device;
withdrawing the second measuring device;
using the second pressing device to press the cellular piece;
using the chopping device to cut the cellular piece; and
releasing the cellular piece pressed by the second pressing device.

4. The method of cutting as claimed in claim 3, wherein the cellular shade is in a state that the beam is in a vertical direction, and the pair of second pressing devices also move upwardly and downwardly, and the chopping device also moves upwardly and downwardly to perform the chopping operation.

5. The method of cutting as claimed in claim 1, wherein the step of performing the cutting of the beams and the step of performing the cutting of the cellular piece is performed in a reversed order.

6. A cutting machine of a cellular shade, applicable for the cutting operation of an assembled cellular shade having at least two beams and at least a cellular piece, the cutting machine comprising:
a table, having a first work area and a second work area in a same plane or in a different plane, providing arrangement of the beams in a long axis direction, wherein the long axis direction is a direction of an X coordinate axis;
a sawing mechanism, disposed in the first work area, and having a first measuring device, a first pressing device, and a sawing device, wherein the first measuring device is disposed on the table and is movable along the direction of the X coordinate axis to adjust a distance to the sawing device, the first pressing device is disposed at another position on the same X coordinate axis of the table, and clamps the beams in a direction of a Y coordinate axis parallel to the first work area plane, the sawing device is disposed between the first measuring device and the first pressing device of the table, and is movable along a Z coordinate axis relative to the X, Y coordinate axes to cut the beams; and
a chopping mechanism, disposed in the second work area, and having a second measuring device, a pair of second pressing devices, and a chopping device, wherein the second measuring device is disposed on the table and is movable along the direction of the X coordinate axis to adjust a distance to the chopping device, the second pressing devices are disposed at another position on the same X coordinate axis of the table, and clamp the cellular piece in the direction of the Z coordinate axis, the chopping device is disposed between the two second pressing devices, and has a chopper moving along the Z coordinate axis to cut the cellular piece.

7. The cutting machine as claimed in claim 6, wherein the first measuring device comprises:
a slide base component fixed on the table, wherein the slide base component has a brake sliding block movable between a first position and a second position, and the brake sliding block has a screw fixing member;
a brake sliding block striding over a vernier and moving freely; and
a positioning block extending from the vernier;
wherein when the first measuring device is actuated, the brake sliding brake is at the first position, and positions of the vernier and the positioning block are adjusted to obtain a cutting distance of the positioning block and the sawing device, and the screw fixing member is used to secure a relative position of the vernier and the brake sliding block, then after the first pressing device presses the beams, the vernier is pulled back to the second position to withdraw the positioning block.

8. The cutting machine as claimed in claim 6, wherein the first pressing device comprises:
a slide base component fixed on the table, wherein the slide base component has a pressure sliding block actively movable along the direction of the Y coordinate axis;
a baffle fixed on the table, wherein the baffle is disposed in a moving direction of the pressure sliding block; and
at least one cushion block linearly, individually, and freely movable between the pressure sliding block and the baffle;
wherein before the pressure sliding block is pushed out and actuated, the beam of the cellular shade is disposed between the cushion block and the pressure sliding block or between the cushion block and the baffle, then after the pressure sliding block is pushed and actuated, the pressure sliding block is pushed to the baffle with the beam and the cushion block to press the beam.

9. The cutting machine as claimed in claim 6, wherein the cushion block is two or more cushion blocks connected in series along the Y coordinate axis and individually movable freely along the Y coordinate axis, when the cellular shade has three or more beams, each of the cushion blocks is disposed between two neighboring beams, so as to provide a middle beam of the cellular shade between the two cushion blocks.

10. The cutting machine as claimed in claim 6, wherein the sawing device comprises:
a slide base component fixed on the table, wherein the slide base component has a sliding mechanism movable along the Z coordinate axis;
a cutter rotating mechanism fixed in the sliding mechanism; and
a saw cutter assembled in the cutter rotating mechanism.

11. The cutting machine as claimed in claim 10, wherein the sawing device further comprises an outer cover to cover the saw cutter, and a microswitch connected to a power source of the saw cutter is disposed on the outer cover, when the outer cover is opened, the power source of the saw cutter is shut down.

12. The cutting machine as claimed in claim 6, wherein the second measuring device comprises:
a slide base component fixed on the table, wherein the slide base component has a brake sliding block movable between a first position and a second position, and the brake sliding block has a screw fixing member;
a brake sliding block striding over a vernier and moving freely; and
a positioning block extending from the vernier;
wherein when the second measuring device is actuated, the brake sliding block is at the first position, and the positions of the vernier and the positioning block are adjusted to obtain a cutting distance of the positioning block and the chopping device, and the screw fixing member is used to secure a relative position of the vernier and the brake sliding block, such that the positioning block is positioned precisely, after the cellular piece is placed against the second measuring device, the brake sliding block is pulled back to the second position, such that the positioning block leaves the cellular shade, and the second pressing devices are used to press the cellular piece before the chopping device is started.

13. The cutting machine as claimed in claim 6, wherein the second pressing device comprises:
a pair of slide base components fixed on the table, wherein each of the pair of slide base components has a pressure sliding block movable along the direction of the Z coordinate axis respectively;
a base plate fixed to the table, wherein the base plate has a groove; and
at least one cushion block linearly, individually, and passively movable between the pressure sliding block and the base plate;
wherein before the pair of pressure blocks are pushed and actuated, the cellular piece of the cellular shade is disposed on the base plate, and after the pressure block is pushed and actuated, the pressure block is pushed to the base plate with the cushion block and the cellular piece to press the cellular piece.

14. The cutting machine as claimed in claim 13, wherein the cellular shade has at least two beams and a cellular piece between every two beams, when the cellular pieces are pressed, the cellular pieces are disposed between the cushion block and the base plate and between the cushion block and the pressure sliding block.

15. The cutting machine as claimed in claim 13, wherein each of the surfaces of the cellular piece in contact with the base plate and the cushion block has a contamination-proof pad.

16. The cutting machine as claimed in claim 15, wherein the contamination-proof pads are of an acrylic or plastic material.

17. The cutting machine as claimed in claim 6, wherein the chopping device comprises:
a slide base component fixed on the table, wherein the slide base component has a sliding mechanism movable along the Z coordinate axis; and
a chopping cutter assembled in the sliding mechanism.

18. The cutting machine as claimed in claim 17, wherein the chopping device comprises a guiding and positioning cover to guide the positioning of the cellular shade.

19. The cutting machine as claimed in claim 6, wherein the chopping device comprises at least one flange portion disposed at a predetermined position in front of the chopping cutter and extending along the direction of the Z coordinate axis to stop the beams.

20. The cutting machine as claimed in claim 19, further comprising a guiding portion disposed at a predetermined position of the table and adjacent to the flange portion, and extending along a direction parallel to the X coordinate axis.
